(19) United States
(12) Patent Application Publication
(10) Pub. No.: US 2026/0138564 A1
(43) Pub. Date: May 21, 2026

(54) INFORMATION PROCESSING METHOD, INFORMATION PROCESSING DEVICE, AND RECORDING MEDIUM

(71) Applicant: Panasonic Intellectual Property Management Co., Ltd., Osaka (JP)

(72) Inventor: Kazuto UENISHI, Fukuoka (JP)

(73) Assignee: Panasonic Intellectual Property Management Co., Ltd., Osaka (JP)

(21) Appl. No.: 19/423,794

(22) Filed: Dec. 17, 2025

Related U.S. Application Data
(63) Continuation of application No. PCT/JP2024/020817, filed on Jun. 7, 2024.

(30) Foreign Application Priority Data
Jun. 28, 2023 (JP) 2023-105945

(51) Int. Cl. B60R 25/24; B60R 25/25

(52) U.S. Cl. CPC B60R 25/24; B60R 25/25

(57) ABSTRACT

An information processing method is an information processing method to be executed by a vehicle communicably connected to an information terminal, and the information processing method includes obtaining license information pertaining to a driver's license of a driver of the vehicle, by communicating with the information terminal, and storing the license information obtained into a storage.

### CROSS REFERENCE TO RELATED APPLICATIONS

This is a continuation application of PCT International Application No. PCT/JP2024/020817 filed on Jun. 7, 2024, designating the United States of America, which is based on and claims priority of Japanese Patent Application No. 2023-105945 filed on Jun. 28, 2023. The entire disclosures of the above-identified applications, including the specifications, drawings and claims are incorporated herein by reference in their entirety.

### FIELD

The present disclosure relates to an information processing method, an information processing device, and a recording medium.

### BACKGROUND

Vehicles in recent years are capable of transmitting and receiving information to and from an outside entity, and a digital key system, for example, has been developed that can lock or unlock the vehicle or start its engine with the use of an information terminal and through the transmission and reception of such information (see, for example, Patent Literature (PTL) 1).

### CITATION LIST

### Patent Literature

PTL 1: Japanese Unexamined Patent Application Publication No. 2023-049595

### SUMMARY

### Technical Problem

Meanwhile, there may be a case in which a vehicle fails to transmit or receive appropriate information.

In view of the above, the present disclosure is directed to providing an information processing method and so forth that enable a vehicle to transmit and receive more appropriate information.

### Solution to Problem

An information processing method according to one aspect of the present disclosure is an information processing method to be executed by a vehicle communicably connected to an information terminal, and the information processing method includes: obtaining license information pertaining to a driver's license of a driver of the vehicle, by communicating with the information terminal; and storing the license information obtained into a storage.

Meanwhile, an information processing device according to one aspect of the present disclosure is an information processing device for a vehicle communicably connected to an information terminal, and the information processing device includes: an obtainer that obtains license information pertaining to a driver's license of a driver of the vehicle, by communicating with the information terminal; and a storage controller that stores the license information obtained into a storage.

Furthermore, one aspect of the present disclosure can be realized in the form of a non-transitory computer readable recording medium having recorded thereon a program that causes a computer to execute the information processing method described above.

It is to be noted that general or specific aspects of the above may be implemented in the form of a system, a device, a method, an integrated circuit, a computer program, or a non-transitory computer readable recording medium, such as a compact disc-read only memory (CD-ROM) or through any desired combinations of a system, a device, a method, an integrated circuit, a computer program, and a recording medium.

### Advantageous Effects

The present disclosure makes it possible for a vehicle to transmit and receive more appropriate information.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram showing a functional configuration of an information processing system according to an embodiment.

FIG. 2 is a schematic diagram showing the content of driver information according to an embodiment.

FIG. 3 is a schematic diagram showing the content of driver information according to an embodiment.

FIG. 4 is a sequence diagram showing an example of an operation of generating and authenticating a digital key according to an embodiment.

FIG. 5 is a sequence diagram showing an example of an operation performed from the starting of the engine to the stopping of it according to an embodiment.

FIG. 6 is a block diagram showing a functional configuration of an information processing system according to a variation of an embodiment.

FIG. 7 is a sequence diagram showing an example of an operation of generating and authenticating a digital key according to a variation of an embodiment.

### DESCRIPTION OF EMBODIMENTS

### Underlying Knowledge Forming Basis of the Disclosure

As described in the section titled Background, vehicles in recent years are capable of connecting to a communication network, such as the internet, and thus of transmitting and receiving information to and from an outside entity. Then, as more and more people own an information terminal, such as a smartphone or a tablet terminal, capable of more advanced information processing, there is an increased demand for the capability that allows one to operate a vehicle with the use of such an information terminal. For example, conventionally, locking or unlocking a vehicle or starting its engine has required a physical key or a dedicated key fob capable of short distance communication with the vehicle. In this respect, as described in PTL 1, the development of digital key systems is in progress that make it possible to lock or unlock a vehicle or start its engine with the use of an information terminal.

Meanwhile, if a vehicle is capable of obtaining information pertaining to the driver's license of the driver of the vehicle, this makes it possible to perform a variety of processes that can enhance the vehicle safety and appropriateness. In other words, in order to perform a variety of processes that can enhance the safety of the vehicle and the appropriateness of the driver's maneuver, there needs to be a way to transmit and receive more appropriate information that enables the vehicle to obtain information pertaining to the driver's license of the driver of the vehicle.

Accordingly, an information processing method and so forth that make it possible for a vehicle to obtain information pertaining to the driver's license of its driver will be described according to the present disclosure.

To be more specific, an information processing method according to a first aspect of the present disclosure is an information processing method to be executed by a vehicle communicably connected to an information terminal, and the information processing method includes: obtaining license information pertaining to a driver's license of a driver of the vehicle, by communicating with the information terminal; and storing the license information obtained into a storage.

According to such an information processing method, transmission and reception of more appropriate information becomes possible through which a vehicle can obtain license information pertaining to a driver's license.

Furthermore, for example, an information processing method according to a second aspect of the present disclosure is the information processing method according to the first aspect in which the obtaining of the license information is performed at least one of when generating, using the information terminal, a digital key to be used to unlock the vehicle and start an engine of the vehicle or when performing authentication using the digital key.

According to the aspect above, the license information can be obtained at the timing when communication between the vehicle and the information terminal occurs, as in generating or authenticating the digital key.

Furthermore, for example, an information processing method according to a third aspect of the present disclosure is the information processing method according to the second aspect in which the authentication using the digital key for obtaining the license information is for starting the engine of the vehicle.

According to the aspect above, the license information can be obtained at the timing when communication between the vehicle and the information terminal occurs, as in generating the digital key or authenticating the digital key to start the engine of the vehicle.

Furthermore, for example, an information processing method according to a fourth aspect of the present disclosure is the information processing method according to the third aspect in which the license information includes a facial photograph of the driver, the obtaining of the license information further includes capturing an image that includes a face of the driver of the vehicle, and the method further comprises permitting the engine of the vehicle to start when the authentication using the digital key succeeds and the facial photograph included in the license information obtained matches the face of the driver of the vehicle included in the image captured.

According to the aspect above, as the face recognition is also performed, the engine can be started upon ensuring that the driver of the vehicle matches the driver in the license information.

Furthermore, for example, an information processing method according to a fifth aspect of the present disclosure is the information processing method according to any one of the second to fourth aspects in which in the obtaining of the license information, the license information is not obtained in authentication using a friend key for unlocking the vehicle, and the license information is obtained in authentication using the friend key for starting the engine of the vehicle, when the friend key is used that is generated based on the digital key generated and that is capable of unlocking the vehicle and starting the engine of the vehicle.

According to the aspect above, in a case in which the friend key is used, unnecessary communication of obtaining the license information to unlock the vehicle can be avoided.

Furthermore, for example, an information processing method according to a sixth aspect of the present disclosure is the information processing method according to any one of the second to fifth aspects in which unlocking of the vehicle and starting of the engine of the vehicle are performed using the digital key in accordance with a digital key standard defined by Car Connectivity Consortium (CCC).

According to the aspect above, the vehicle can be unlocked and the engine can be started using the digital key in accordance with the digital key standard defined by the CCC.

Furthermore, for example, an information processing method according to a seventh aspect of the present disclosure is the information processing method according to any one of the first to sixth aspects that includes, when the license information is stored in the storage, obtaining the license information stored (in the storage) instead of performing the obtaining of the license information.

According to the aspect above, in a case in which the license information is stored, the stored license information can be obtained alternatively to newly obtaining license information.

Furthermore, for example, an information processing method according to an eighth aspect of the present disclosure is the information processing method according to any one of the first to seventh aspects in which in the obtaining of the license information, inquiry information for making an inquiry to a management server that manages the license information is obtained from the information terminal, and the license information is obtained by making an inquiry to the management server using the inquiry information.

According to the aspect above, the license information can be obtained from the management server that manages the license information. Therefore, in a case in which the management server manages the latest license information, that latest license information can be obtained.

Furthermore, for example, an information processing method according to a ninth aspect of the present disclosure is the information processing method according to any one of the first to eighth aspects in which in the obtaining of the license information, the license information stored in the information terminal is obtained.

According to the aspect above, the license information stored in the information terminal can be obtained without making an inquiry, for example, to the management server. The information terminal often engages in communication, for example, when generating a digital key of the vehicle, locking or unlocking the vehicle, or starting the engine of the vehicle, and the license information can be obtained at the timing when such communication is established.

Furthermore, for example, an information processing method according to a tenth aspect of the present disclosure is the information processing method according to any one of the first to ninth aspects in which the license information includes a name of the driver, and the information processing method further comprises outputting an audio message including the name of the driver through a loudspeaker of the vehicle.

According to the aspect above, an audio message can be output that includes the name in the license information when the vehicle outputs a message.

Furthermore, for example, an information processing method according to an eleventh aspect of the present disclosure is the information processing method according to any one of the first to tenth aspects in which in the storing of the license information, the license information obtained is stored into at least one of the storage provided in the vehicle, the storage installed in a management server of the vehicle, or the storage provided in the information terminal.

According to this aspect, the obtained license information can be stored into at least one of the storage provided in the vehicle, the storage installed in the management server of the vehicle, or the storage provided in the information terminal.

Furthermore, for example, an information processing method according to a twelfth aspect of the present disclosure is the information processing method according to any one of the seventh to eleventh aspects that depend from any one of the second to sixth aspects or the second aspect that further includes: obtaining setting information pertaining to a setting of the vehicle set by the driver and storing the setting information into a setting storage with the setting information in association with the license information of the driver; and after the authentication using the digital key, changing the setting of the vehicle based on the setting information stored in the setting storage.

According to the aspect above, the setting of the vehicle can be changed based on the setting information that includes, for example, the past setting made by the driver identified by the license information.

Furthermore, for example, an information processing method according to a thirteenth aspect of the present disclosure is the information processing method according to the twelfth aspect in which the setting information stored is updated based on setting information newly obtained and set by the driver of the vehicle.

According to the aspect above, based on the newly obtained setting information, the stored setting information can be updated to setting information that includes the latest state.

Furthermore, for example, an information processing method according to a fourteenth aspect of the present disclosure is the information processing method according to any one of the first to thirteenth aspects that further includes: obtaining a driving history of the driver of the vehicle and storing the driving history into a history storage with the driving history in association with the license information of the driver; and calculating, by a navigation system provided in the vehicle, at least one of a recommended route to a destination or an estimate time of arrival at the destination, wherein in the calculating of the at least one of the recommended route to the destination or the estimated time of arrival at the destination, the recommended route and the estimated time of arrival are calculated based on the driving history stored in the history storage.

According to the aspect above, at least one of the recommend route that is more suitable for the driver or the estimated time of arrival can be calculated based on the driving history.

Furthermore, for example, an information processing method according to a fifteenth aspect of the present disclosure is the information processing method according to any one of the first to fourteenth aspects that further includes: obtaining a driving history of the driver of the vehicle and storing the driving history into a history storage with the driving history in association with the license information of the driver; and second calculating, by a fuel efficiency computing system provided in the vehicle, of at least one of fuel efficiency information in traveling or a travelable distance with fuel remaining in the vehicle, wherein in the second calculating, the fuel efficiency information and the travelable distance are calculated based on the driving history stored in the history storage.

According to the aspect, at least one of the fuel efficiency information that is more suitable for the driver or the distance that can be traveled with the fuel remaining in the vehicle can be calculated based on the driving history.

Furthermore, for example, an information processing method according to a sixteenth aspect of the present disclosure is the information processing method according to any one of the first to fifteenth aspects that further includes: providing a notification to an outside entity in response to an occurrence of a trouble to involving vehicle, the providing of the notification including sending a notification that includes the license information to the outside entity.

According to the aspect above, when a trouble occurs, a notification that includes the license information can be set to an outside entity.

Furthermore, for example, an information processing method according to a seventeenth aspect of the present disclosure is the information processing method according to any one of the first to sixteenth aspects in which the license information is obtained in accordance with a mobile Driver License (mDL) standard.

According to the aspect above, the license information can be obtained in accordance with the mDL standard.

Furthermore, for example, an information processing method according to an eighteenth aspect of the present disclosure is the information processing method according to any one of the first to seventeenth aspects in which the license information includes at least one of a license type indicating a type of vehicle that the driver is permitted to drive, a facial photograph of the driver, a name of the driver, a restriction indicating a condition in which the driver is permitted to drive, or an expiration date.

According to the aspect above, the license information can be obtained that includes at least one of the license type indicating the type of vehicle that the driver is permitted to drive, a facial photograph of the driver, the name of the driver, restrictions indicating a condition in which the driver is permitted to drive, or the expiration date.

Furthermore, for example, a recording medium according to a nineteenth aspect of the present disclosure is a non-transitory computer readable recording medium having recorded thereon a program that causes a computer to execute the information processing method according to any one of the first to eighteenth aspects.

According to the aspect above, as the program is executed with the use of a computer, advantageous effects similar to those provided by the information processing methods described above can be obtained.

Furthermore, for example, an information processing device according to a twentieth aspect of the present disclosure is an information processing device for a vehicle communicably connected to an information terminal, and the information processing device includes: an obtainer that obtains license information pertaining to a driver's license of a driver of the vehicle, by communicating with the information terminal; and a storage controller that stores the license information obtained into a storage.

According to the aspect above, advantageous effects similar to those provided by the information processing methods described above can be obtained.

It is to be noted that general or specific aspects of the above may be implemented in the form of a system, a device, a method, an integrated circuit, a computer program, or a non-transitory computer readable recording medium, such as a CD-ROM or through any desired combinations of a system, a device, a method, an integrated circuit, a computer program, and a recording medium.

Hereinafter, some embodiments will be described in concrete terms with reference to the drawings. The embodiments described below merely illustrate general or specific examples. The numerical values, the shapes, the materials, the constituent elements, the arrangement positions and the connection modes of the constituent elements, the steps, the order of the steps, and so on illustrated according to the following embodiments are examples and are not intended to limit the present disclosure. Furthermore, among the constituent elements described according to the following embodiments, any constituent elements that are not cited in the independent claims are to be construed as optional constituent elements. The drawings are schematic diagrams and do not necessarily provide the exact depiction. Moreover, in the drawings, substantially identical configurations are given identical reference characters, and duplicate description thereof may be omitted or simplified.

Furthermore, there may be a case in which an ordinal number, such as first, second, or third, is added to an element. These ordinal numbers are added in order to differentiate one element from another and do not necessarily indicate any meaningful order of the elements. These ordinal numbers may be switched thereamong as appropriate, a different ordinal number may be appended to an element, or these ordinal numbers may altogether be removed.

### Embodiment

### Configuration

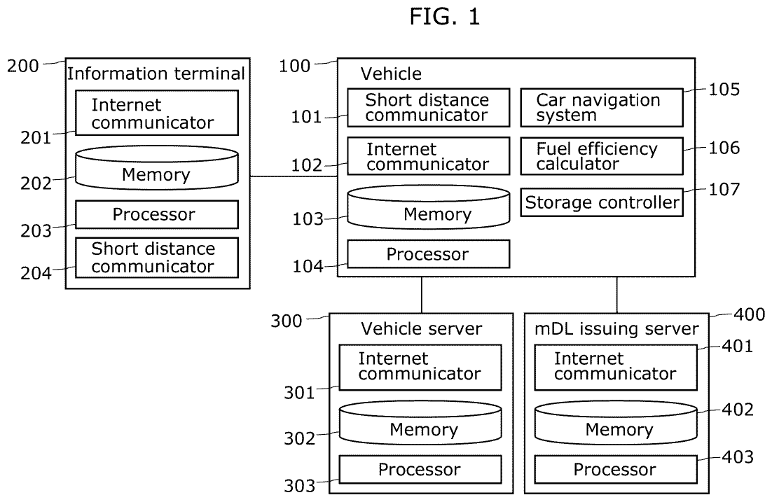

First, a configuration of an information processing system according to an embodiment will be described. FIG. 1 is a block diagram showing a functional configuration of an information processing system according to an embodiment. As shown in FIG. 1, an information processing system according to the present embodiment includes vehicle 100, information terminal 200, vehicle server 300, and mDL issuing server 400. Vehicle 100 is a mobile body that runs as it is driven by its driver.

Vehicle 100 includes short distance communicator 101, internet communicator 102, memory 103, processor 104, car navigation system 105, fuel efficiency calculator 106, and storage controller 107. It is to be noted that, here, only the constituent elements of vehicle 100 that pertain to information processing are shown in the drawing, and vehicle 100 also includes, aside from those listed above, an electronic control unit (ECU), instruments, a chassis, the body, the driving mechanism, a power source, and so forth (none of which are shown).

Short distance communicator 101 is a communication module for vehicle 100 to communicate with information terminal 200. Short distance communicator 101 includes, for example but not limited to, a Bluetooth Low Energy (BLE) communication module that uses Bluetooth (registered trademark), a near field communication (NFC) communication module, and an ultra-wide band (UWB) communication module that compensates for the communication vulnerability of the BLE communication module. Herein, the configuration of short distance communicator 101 is not limited to the one described above, and any system or module may be used as long as such a system or module is capable of wirelessly communicating with information terminal 200.

Internet communicator 102 is a communication module for vehicle 100 to communicate, for example, with an outside server. Internet communicator 102 communicates, for example, with an outside server via a base station, for example, through mobile wireless communication. The communication between internet communicator 102 and, for example, an outside server includes obtaining of license information from, for example, mDL issuing server 400. Therefore, internet communicator 102 can also be regarded as an obtainer.

Memory 103 is a storage device for storing information and is implemented, for example, by a semiconductor memory or a magnetic memory. Memory 103 may store license information, and in that case, memory 103 can be regarded as a storage. Furthermore, memory 103 may store setting information pertaining to the settings of the vehicle and the driving history of the driver of the vehicle, and in that case, memory 103 can be regarded as a setting storage as well as a history storage. Herein, it suffices that the license information, the setting information, and the driving history be stored with these items of information in association with each other, and these items of information may be stored in separate storages. In the example described according to the present embodiment, the set consisting of the license information, the setting information, and the driving history, the vehicle information, and the digital key are all stored in a single storage with these items of information in association with each other. Memory 103 stores therein a program to be executed by processor 104 described later and various items of data that are read out or stored in accordance with the program.

Processor 104 is a logic element for performing information processing. Processor 104 executes a program stored in memory 103 and thus performs information processing in vehicle 100. In particular, processor 104 performs processes such as obtaining the license information, generating and authenticating a digital key, and sending information to an outside entity.

Car navigation system 105 is a device that instructs the driver how to navigate vehicle 100 to reach a destination, or a target location to which vehicle 100 is to reach, from the current location by connecting appropriate routes between the current location and the destination. Car navigation system 105 includes therein, for example, a memory storing map information and a program for calculating a route, a processor for executing the program, a positioning device for finding the current location. Car navigation system 105 according to the present embodiment is equipped with a function that, upon receiving information from vehicle 100, calculates a route matching the received information. This function will be described later. Car navigation system 105 talks to the driver via synthesized speech. In this case, car navigation system 105 may use the driver's name obtained from the license information and talk to the driver using the obtained name.

Fuel efficiency calculator 106 is a processor that calculates fuel efficiency information indicating the fuel efficiency of vehicle 100 in the current state. Fuel efficiency calculator 106 includes therein, for example, a communication module that obtains information necessary for the calculation, a memory storing, for example, a program that calculates the fuel efficiency information, and a processor that executes the program. Fuel efficiency calculator 106 according to the present embodiment is equipped with a function that, upon receiving information from vehicle 100, calculates fuel efficiency information matching the received information. This function will be described later.

Storage controller 107 is a processor for storing obtained information into a storage. Specifically, storage controller 107 stores obtained license information into an outside storage or a storage in vehicle 100. Storage controller 107 stores the driver information including the obtained license information into a storage. In a case in which driver information is generated from the license information, by linking another item of information to the license information with the use of an ID or the like, the corresponding license information may be referred to based on that other item of information, or the corresponding other item of information may be referred to based on the license information.

In addition to those described above, vehicle 100 includes an image capturing device (not shown). Such an image capturing device is provided in an orientation that allows the image capturing device to capture an image of the driver's seat, in particular, an image of the area including the headrest from the side where the windshield is located. As a result, the image capturing device can capture an image that includes the face of the user (the user who is most likely the driver) sitting in the driver's seat. The image capturing device outputs a captured image to processor 104.

Information terminal 200 is a terminal device, such as a smartphone, a tablet terminal, or a personal computer (PC), that the user, such as the driver, of vehicle 100 carries and that is capable of information processing. Information terminal 200 includes internet communicator 201, memory 202, processor 203, and short distance communicator 204.

Internet communicator 201 is a communication module for information terminal 200 to communicate, for example, with an outside server. Internet communicator 201 communicates, for example, with an outside server via a base station, for example, through mobile wireless communication.

Memory 202 is a storage device for storing information and is implemented, for example, by a semiconductor memory or a magnetic memory. Memory 202 may store license information, and in that case, memory 202 can be regarded as a storage. Memory 202 stores therein a program to be executed by processor 203 described later and various items of data that are read out or stored in accordance with the program.

Processor 203 is a logic element for performing information processing. Processor 203 executes a program stored in memory 202 and thus performs information processing in information terminal 200. In particular, processor 203 performs processes such as receiving license information, storing the received license information into a storage, and generating and authenticating a digital key.

Short distance communicator 204 is a communication module for information terminal 200 to communicate with vehicle 100. Short distance communicator 204 includes, for example but not limited to, a BLE communication module that uses Bluetooth (registered trademark), an NFC communication module, and a UWB communication module that compensates for the communication vulnerability of the BLE communication module. Herein, the configuration of short distance communicator 204 is not limited to the one described above, and any system or module may be used as long as such a system or module is capable of wirelessly communicating with vehicle 100. Herein, as short distance communicator 204 wirelessly communicates with vehicle 100, a wireless communication system or module similar to that of short distance communicator 101 of vehicle 100 is used for short distance communicator 204.

Vehicle server 300 is an information management server operated, for example, by the manufacturer of vehicle 100 or the managing company of vehicle 100 and is realized, for example, by an edge server or a cloud server. Vehicle server 300 includes internet communicator 301, memory 302, and processor 303.

Internet communicator 301 is a communication module for vehicle server 300 to communicate, for example, with an outside server. In a case in which vehicle server 300 is realized by a cloud server, internet communicator 301 performs communication, for example, by obtaining information from an outside server via a communication network, such as the internet.

Memory 302 is a storage device for storing information and is implemented, for example, by a semiconductor memory or a magnetic memory. Memory 302 may store license information, and in that case, memory 302 can be regarded as a storage. Memory 302 stores therein a program to be executed by processor 303 described later and various items of data that are read out or stored in accordance with the program.

Processor 303 is a logic element for performing information processing. Processor 303 executes a program stored in memory 302 and thus performs information processing in vehicle server 300. In particular, processor 303 performs processes such as receiving license information and storing the received license information into a storage.

MDL issuing server 400 is an information management server operated by a public organization (e.g., the National Police Agency or the like) that plays a part in issuing a driver's license and is realized, for example, by an edge server or a cloud server. MDL issuing server 400 includes internet communicator 401, memory 402, and processor 403.

Internet communicator 401 is a communication module for mDL issuing server 400 to communicate, for example, with an outside server. In a case in which mDL issuing server 400 is realized by a cloud server, internet communicator 401 performs communication, for example, by transmitting information corresponding to an inquiry from an outside server 400 via a communication network, such as the internet.

Memory 402 is a storage device for storing information and is implemented, for example, by a semiconductor memory or a magnetic memory. Memory 402 holds license information pertaining to a driver's license that, for example, the public organization mentioned above has taken part in its issuance. The license information is, of the information appearing on the driver's license, information that can be digitized and that indicates the information identical to what appears on the driver's license.

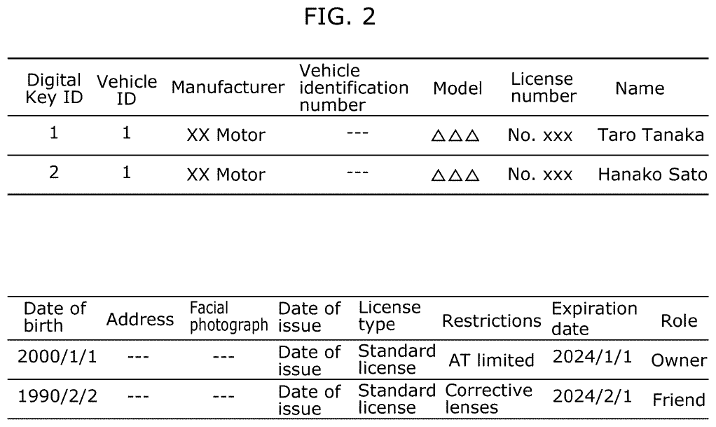

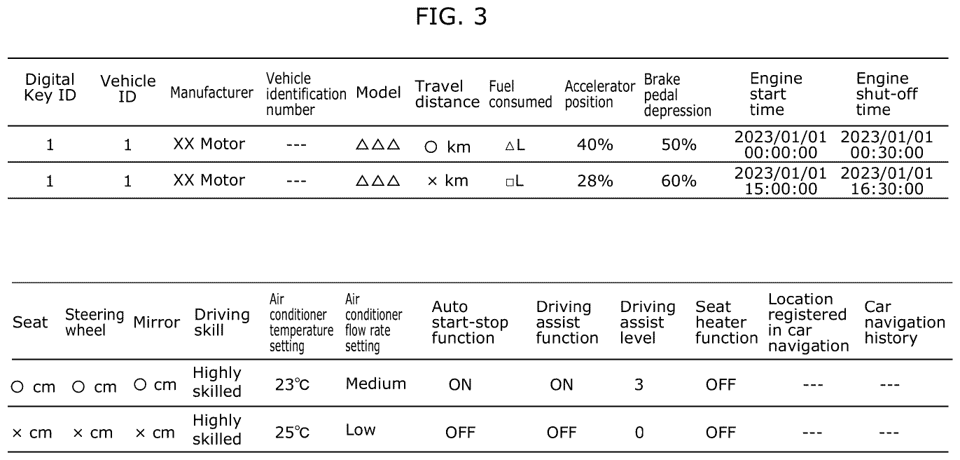

Now, FIG. 2 is a schematic diagram showing the content of driver information in which license information, vehicle information, and a digital key are in association with each other. Meanwhile, FIG. 3 is a schematic diagram showing the content of driver information in which vehicle information, setting information, and a driving history are in association with each other. It is to be noted that FIG. 2 and FIG. 3 each show two drawings separated in the upper half and the lower half, and the leading end (the left end) of the drawing in the lower half is the continuation from the trailing end (the right end) of the drawing in the upper half.

As shown in FIG. 2, the driver information includes information pertaining to a digital key, including the ID of the digital key (Digital Key ID), the ID of vehicle 100 (Vehicle ID), and the role of the digital key. Furthermore, the driver information includes vehicle information including the manufacturer of vehicle 100, the vehicle identification number of vehicle 100, and the model of vehicle 100. Although not shown in the drawing, the vehicle information may also include information identifying the type of a required license. Meanwhile, the driver information includes license information including the license number, the name of the driver, the date of birth of the driver, the address of the driver, a facial photograph of the driver, the date of issue of the driver's license, the license type indicating the type of vehicle or vehicles that the driver is permitted to drive, the restrictions indicating the conditions in which the driver is permitted to drive, and the expiration date of the driver's license.

Furthermore, as shown in FIG. 3, the driver information includes a driving history summarizing the history of driving covering the period from when the engine is started to when the engine is shut off. FIG. 3 includes two instances of the driving history of “Taro Tanaka” with a digital key ID of “1”. As for the driving history, driver information may be generated (updated) such that the driving history includes only the latest instance of driving, or driver information may be generated (updated) such that the driving history includes multiple instances of driving as shown in FIG. 3. The driving history includes the travel distance, the fuel consumed, the accelerator position, the brake pedal depression, the engine start time, and the engine shut-off time. The driver information further includes the seat position, the steering wheel position, the orientation of the mirrors, the driving skill, the set temperature of the air conditioner, the set flow rate of the air conditioner, the use or non-use of the auto start-stop function, the use or non-use of the driving assist function, the assist level of the driving assist function, the use or non-use of the seat heater function, the locations registered in the car navigation system (i.e., car navigation system 105), and the car navigation history. According to the present embodiment, the use of such driver information enables a variety of processes described later and makes it possible to increase the vehicle safety and the appropriateness of driving maneuvers.

Referring back to FIG. 1, processor 403 is a logic element for performing information processing. Processor 403 executes a program stored in memory 402 and thus performs information processing in mDL issuing server 400. In particular, processor 403 performs processes such as transmitting license information.

### Operation

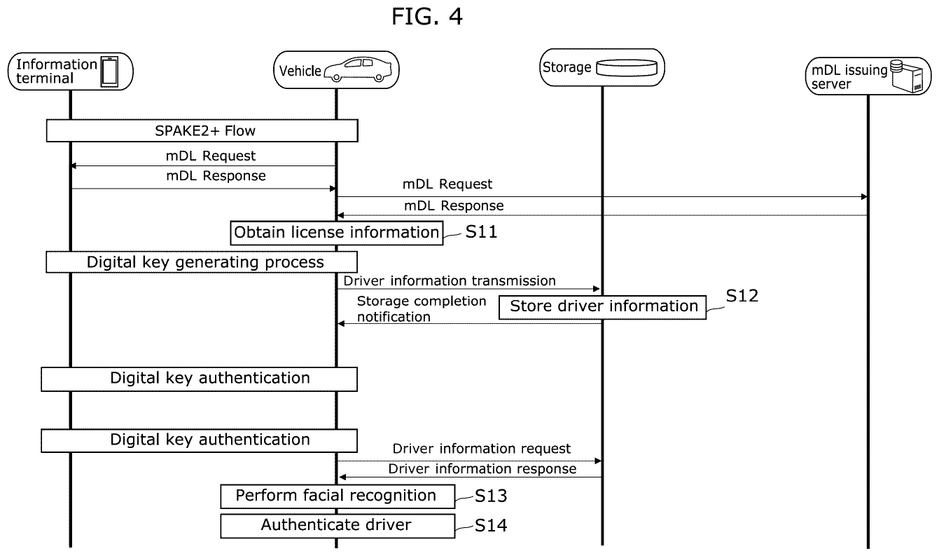

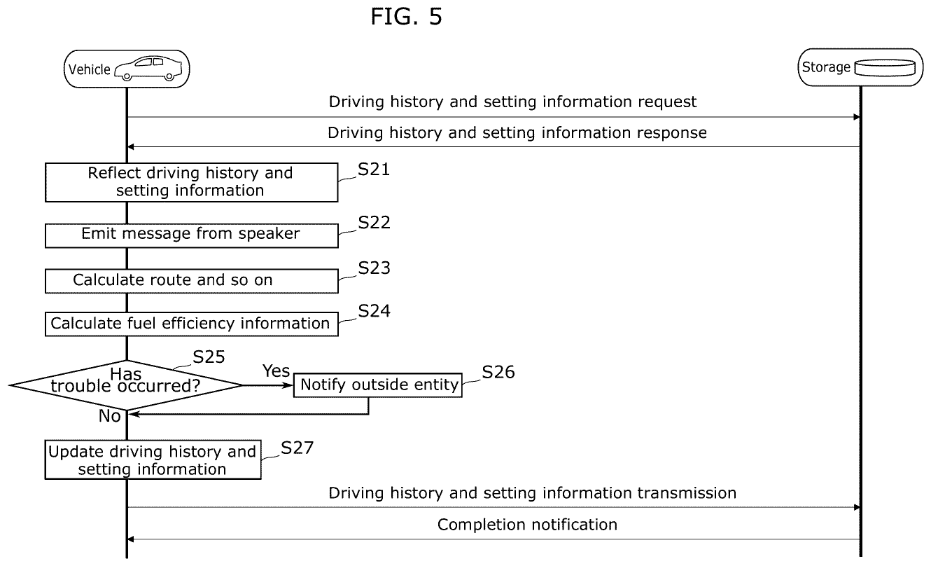

Next, an operation of the information processing system described above will be described with reference to FIG. 4 and FIG. 5. FIG. 4 is a sequence diagram showing an example of an operation of generating and authenticating a digital key according to an embodiment. FIG. 5 is a sequence diagram showing an example of an operation performed from the starting of the engine to the stopping of it according to an embodiment.

As shown in FIG. 4, first, a digital key is generated for locking or unlocking vehicle 100 and starting the engine. In this example, the generating of the digital key, the locking and unlocking of vehicle 100 through the authentication of the digital key, and the starting of the engine through the authentication of the digital key are performed based on the digital key standard defined by the Car Connectivity Consortium (CCC).

First, as a preparation, in accordance with the digital key standard defined by the CCC, a digital key is authenticated as the owner through the SPAKE2+Flow, and a secure channel (an encrypted communication path) is established. Herein, the SPAKE2+Flow is merely one example, and any method can be employed as long as that method can authenticate a digital key as the owner and establish a secure channel (an encrypted communication path). In this example, a so-called owner key is generated through the encrypted communication. The information about the generated owner key is stored in memory 202 of information terminal 200. It is to be noted that since there is a case in which memory 202 includes a region, called a secure element, that is hard to attack, the information about the owner key is stored preferably in such a secure element.

Information terminal 200 used to generate the owner key is assumed to be a terminal carried by the owner, and thus, in this example, vehicle 100 obtains the license information and generates the driver information. Specifically, first, vehicle 100 requests, from information terminal 200, inquiry information for making an inquiry to mDL issuing server 400. Next, in response to receiving the inquiry information from information terminal 200, vehicle 100 makes an inquiry to mDL issuing server 400 with the use of the inquiry information and can thus obtain the license information of the owner from mDL issuing server 400 (obtaining step S11). The license information is obtained in accordance with the mobile Driver License (mDL) standard.

In particular, since there is a case in which it takes time to obtain the license information in response to an inquiry to mDL issuing server 400, generating an owner key at the same time in this manner advantageously renders it unnecessary to separately spend time on obtaining the license information. Meanwhile, from the second time and then on, that is, once the license information has been obtained, the obtained license information can be used. Therefore, as will be described below, in a case in which driver information including license information is stored in a storage, an alternative obtaining step of obtaining the stored license information may be performed in place of the obtaining step. In other words, if the obtaining step has been performed at least once, thereafter, an alternative obtaining step can obtain driver information including stored license information. However, since there is a case in which license information is modified, even if license information is stored in a storage, the obtaining step may be performed periodically (e.g., once a month or once a year).

Next, what is called an owner key is generated over encrypted communication through a digital key generating process. In the digital key generating process, first, a private key of a public key encryption system owned by the owner is generated. The information about the generated private key is stored into memory 202 of information terminal 200. Information terminal 200 sends the public key certificate in association with the generated private key to vehicle 100, and vehicle 100, upon verifying the issuer of the public key certificate, stores the public key certificate into memory 103 as owner information.

Furthermore, vehicle 100, too, generates a private key of a public key encryption system in a similar manner and stores the generated private key into memory 103 of vehicle 100. Vehicle 100 sends the public key certificate in association with the generated private key to information terminal 200, and information terminal 200, upon verifying the issuer of the public key certificate, stores the public key certificate into memory 202 as vehicle information. Through such a series of digital key generating processes, the private key generated by information terminal 200 comes to serve as the owner key.

Herein, it is not a limitation that the private key of the public key encryption system is generated and the public key certificate in association with that private key is generated at the time of the digital key generating process, and such a private key and the public key certificate linked thereto may be prepared in advance.

Vehicle 100 generates driver information based on the obtained license information, transmits the generated driver information to a storage, and stores it into the storage (storing step S12). The storage may be memory 103 of vehicle 100, memory 202 of information terminal 200, or memory 302 of vehicle server 300.

In the description that follows, the communication between information terminal 200 and vehicle 100 for authenticating the digital key is performed by the standard transaction.

Next, information terminal 200 and vehicle 100 communicate with each other to authenticate the digital key. In this example, information terminal 200 is brought closer to a door of vehicle 100 to establish communication between information terminal 200 and vehicle 100, and thus the authentication is performed. Then, when the authentication is successful, the door lock of vehicle 100 is released.

Furthermore, information terminal 200 and vehicle 100 communicate with each other to authenticate the digital key. In this example, information terminal 200 is brought to a predetermined position set near the infotainment panel of vehicle 100 to establish communication between information terminal 200 and vehicle 100, and thus the authentication is performed. Then, when the authentication is successful, the process of starting the engine of vehicle 100 begins. First, vehicle 100 requests the driver information stored in the storage and obtains the driver information transmitted in response to the request. Since the driver information includes the license information, the facial photograph included in the license information is also obtained at this time.

According to the present embodiment, the starting of the engine of vehicle 100 is permitted if the authentication through the digital key has succeeded and the biometric authentication has also succeeded. Specifically, face recognition is performed between the facial photograph included in the obtained driver information and the face of the driver of vehicle 100 included in an image captured by an image capturing device installed in vehicle 100 (step S13). If these faces match, the driver is authenticated (step S14), and the starting of the engine of vehicle 100 is then permitted. Herein, as the biometric authentication, fingerprint recognition may be performed in place of such a facial recognition. In that case, the fingerprints of the driver may be registered in the driver information, or if information about the fingerprints is included in the license information, that information may be used.

Through such a process, the fact that the user sitting in the driver's seat is the appropriately licensed user whose license information can be obtained (i.e., that the user holds the driver's license) can be ensured. Furthermore, determining whether or not to start the engine based on the license information makes it possible to include, into the conditions for starting the engine, whether the driver's license is a license appropriate for driving vehicle 100 (e.g., the type of the license, the restrictions, the expiration date, etc.).

Thereafter, an operation for starting the engine (e.g., stepping on the brake and depressing a predetermined start button) is performed, and the engine then starts.

Next, an example of operation performed after the engine has started will be described with reference to FIG. 5. As shown in FIG. 5, first, vehicle 100 requests for and obtains the driver information and thus performs an operation equivalent to requesting for and obtaining a driving history and setting information. This operation may be performed in concert with obtaining the driver information before the engine is started, or this operation and the obtaining of the driver information before the engine is started may be performed separately. For example, in a case in which there exist driver information that includes a driving history and setting information and driver information that includes license information, these items of driver information may be obtained separately.

Reflecting the obtained driver information and setting information in vehicle 100 (step S21) makes it possible to cause vehicle 100 to operate in a manner suitable for this driver. First, based on the obtained setting information, the seat position, the position of the steering wheel, the orientation of the mirrors, the air conditioner setting, the ON/OFF setting of various functions, and the operation parameters of these various functions are reset so as to match the settings held when this driver has driven vehicle 100 in the past. For example, vehicle 100 may be configured to automatically revert the settings, for example, to the base positions, the base settings, and the base parameters when the engine is shut off, and the settings may be modified from these base positions, the base settings, the base parameters, and so forth to the positions, the settings, the parameters, and so forth that are based on the obtained setting information. Alternatively, the settings may be modified from the latest positions, the latest settings, the latest parameters, and so forth to the positions, the settings, the parameters, and so forth that are based on the obtained setting information.

Next, once the engine of vehicle 100 starts, a welcoming message is output audibly from a loudspeaker (message outputting step S22). In this case, if the message contains the name of the driver included in the obtained driver information, such as saying “Good morning, Taro-san”, this can give the driver a feeling of familiarity and is preferable. Other messages output at different timings may also contain the name of the driver as appropriate.

Next, with the use of the obtained driving history, car navigation system 105 calculates the route suitable for this driver and the estimated time of arrival (first calculation step S23). Furthermore, with the use of the obtained driving history, the fuel efficiency information that is based on the past driving tendency of this driver, that is, at least one of the travel distance that can be covered per unit amount of fuel in the traveling of vehicle 100 or the distance that can be traveled with the remaining fuel is calculated (second calculation step S24). The fuel in this example is construed broadly to include what is called fossil fuel, such as gasoline and natural gas, and the electricity charged in a vehicle that uses electric power, such as a hybrid vehicle or an electric vehicle.

Thereafter, the traveling starts. When vehicle 100 is in operation, such as when traveling, an occurrence of a trouble (e.g., an accident) may be detected automatically by a sensor, such as a collision sensor, or may be detected through the driver's operation, such as depressing an emergency report button. If an occurrence of a trouble is detected (Yes at step S25), a notification is sent to an outside entity informing that the trouble has occurred (notification step S26). In this example, the notification sent to an outside entity includes the license information. An outside entity may be an organization to which the dispatch of an emergency vehicle is requested, such as the police, the fire department, or the emergency medical service agency, may be an organization concerning the processes performed after the occurrence of the trouble, such as the auto manufacturer or an insurance company, or may be an information terminal of the driver's relative. As the notification sent in this example includes the license information, various determinations can be made with the use of the license information, and thus this example is preferable. Meanwhile, if no occurrence of a trouble is detected (No at step S25), the engine is shut off (not shown), and the process proceeds to step S27.

At step S27, with the use of the driving history and setting information newly obtained in this traveling, the driving history and the setting information in the driver information stored in the storage are updated. Herein, vehicle 100 transmits the driving history and the setting information to the storage and causes the storage to update the information.

### Variation

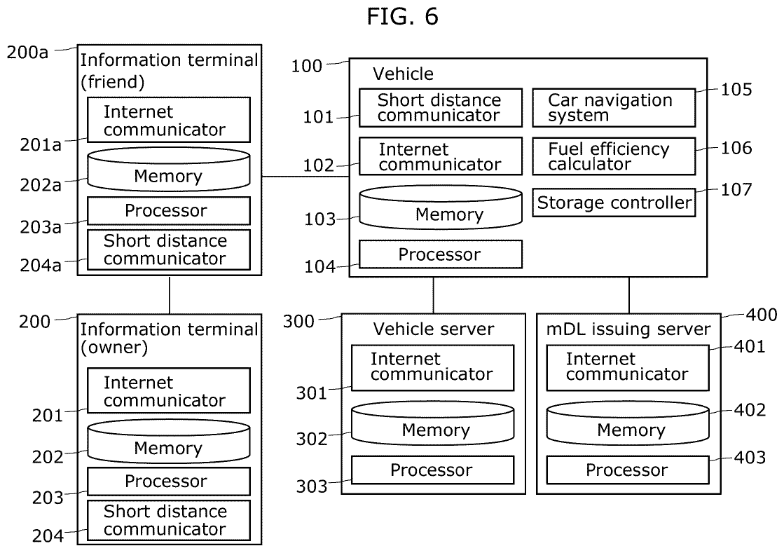

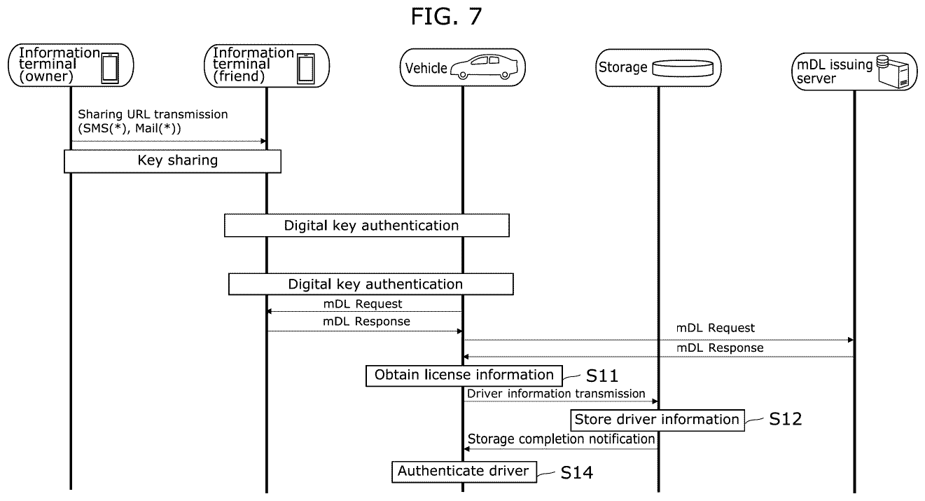

Next, an information processing system according to a variation will be described. In the description below, features similar to those according to the foregoing embodiment are given identical reference characters, and description thereof will be omitted or simplified. The following description centers on the differences. FIG. 6 is a block diagram showing a functional configuration of an information processing system according to a variation of the embodiment. FIG. 7 is a sequence diagram showing an example of an operation of generating and authenticating a digital key according to the variation of the embodiment. In the example described according to the present variation, a friend key is used that is generated based on an already generated digital key and that can unlock vehicle 100 and start the engine. As shown in FIG. 6, this friend key, based on a digital key generated in information terminal 200, allows another information terminal 200a to lock or unlock vehicle 100 and start the engine. Therefore, information terminal 200a has a configuration substantially identical to that of information terminal 200. Specifically, information terminal 200a includes internet communicator 201a similar to internet communicator 201, memory 202a similar to memory 202, processor 203a similar to processor 203, and short distance communicator 204a similar to short distance communicator 204.

Then, as shown in FIG. 7, first, a process of key sharing from information terminal 200 (the owner) to information terminal 200a (a friend), that is, a process of generating a friend key with the use of the owner key and transmitting the generated friend key to information terminal 200a is performed. In this example, the URL used to access to obtain the friend key is transmitted to information terminal 200a with the use of URL sharing. Since the operation performed thereafter is substantially identical to the one described with reference to FIG. 4, description thereof will be omitted. However, in a case in which a friend key is used, since license information is not obtained as in the case of generating the owner key, the license information is obtained in the information processing performed prior to starting the engine. Specifically, in a case in which a friend key is used, license information is not obtained at the time of digital key authentication performed with the use of the friend key for unlocking vehicle 100, but license information is obtained at the time of digital key authentication performed with the use of a friend key for starting the engine of vehicle 100.

A rationale for this is that there may be a case in which the friend key is assigned, as one of its usages, not to drive vehicle 100 but only to unlock a door of vehicle 100. If that is the case, there is a chance that a user who does not have a driver's license unlocks vehicle 100, and thus the license information is obtained in starting the engine that substantially ensures that vehicle 100 is actually driven. With this configuration, the license information is obtained in order to allow the driver to drive vehicle 100, and if a user is only to unlock a door of vehicle 100, no license information is obtained. This is advantageous in that unnecessary communication can be avoided.

### Other Embodiments

Thus far, an embodiment has been described, but the embodiment described above does not limit the present disclosure.

For example, a process executed by a specific processor according to the foregoing embodiment may be executed by another processor. Furthermore, the order of a plurality of processes may be modified, or a plurality of processes may be executed in parallel.

The constituent elements according to the foregoing embodiment may each be implemented through the execution of a software program suitable for the corresponding constituent element. The constituent elements may each be implemented as a program executing unit, such as a central processing unit (CPU) or a processor, reads out a software program recorded in a recording medium, such as a hard disk or a semiconductor memory, and executes the software program.

Meanwhile, the constituent elements may each be implemented by hardware. For example, the constituent elements may each be a circuit (or an integrated circuit). These circuits may be configured as a single circuit as a whole or may be configured as respectively separate circuits. Furthermore, these circuits may each be a general purpose circuit or a dedicated circuit.

Furthermore, general or specific aspects of the present disclosure may be implemented in the form of an apparatus, a device, a method, an integrated circuit, a computer program, or a computer readable recording medium, such as a CD-ROM. Furthermore, general or specific aspects of the present disclosure may be implemented through desired combinations of an apparatus, a device, a method, an integrated circuit, a computer program, and a recording medium.

For example, the present disclosure may be implemented in the form of an information processing method to be executed by a computer or in the form of a program that causes a computer to execute an information processing method. The present disclosure may be realized in the form of a non-transitory computer readable recording medium having such a program recorded thereon.

In addition to the above, an embodiment obtained by making various modifications that a person skilled in the art can conceive of to the foregoing embodiments or an embodiment achieved by combining, as desired, constituent elements and functions according to the foregoing embodiments within the scope that does not depart from the spirit of the present invention is also encompassed by the present disclosure.

### INDUSTRIAL APPLICABILITY

The present disclosure is useful in a situation in which there is a desire to use information about the driver of a vehicle.

1. An information processing method to be executed by a vehicle communicably connected to an information terminal, the information processing method comprising:
obtaining license information pertaining to a driver's license of a driver of the vehicle, by communicating with the information terminal; and
storing the license information obtained into a storage.

2. The information processing method according to claim 1, wherein
the obtaining of the license information is performed at least one of when generating, using the information terminal, a digital key to be used to unlock the vehicle and start an engine of the vehicle or when performing authentication using the digital key.

3. The information processing method according to claim 2, wherein
the authentication using the digital key for obtaining the license information is for starting the engine of the vehicle.

4. The information processing method according to claim 3, wherein
the license information includes a facial photograph of the driver,
the obtaining of the license information further includes capturing an image that includes a face of the driver of the vehicle, and
the method further comprises permitting the engine of the vehicle to start when the authentication using the digital key succeeds and the facial photograph included in the license information obtained matches the face of the driver of the vehicle included in the image captured.

5. The information processing method according to claim 2, wherein
in the obtaining of the license information, the license information is not obtained in authentication using a friend key for unlocking the vehicle, and the license information is obtained in authentication using the friend key for starting the engine of the vehicle, when the friend key is used that is generated based on the digital key generated and that is capable of unlocking the vehicle and starting the engine of the vehicle.

6. The information processing method according to claim 2, wherein
unlocking of the vehicle and starting of the engine of the vehicle are performed using the digital key in accordance with a digital key standard defined by Car Connectivity Consortium (CCC).

7. The information processing method according to claim 1, comprising:
when the license information is stored in the storage, obtaining the license information stored (in the storage) instead of performing the obtaining of the license information.

8. The information processing method according to claim 1, wherein
in the obtaining of the license information,
inquiry information for making an inquiry to a management server that manages the license information is obtained from the information terminal, and
the license information is obtained by making an inquiry to the management server using the inquiry information.

9. The information processing method according to claim 1, wherein
in the obtaining of the license information, the license information stored in the information terminal is obtained.

10. The information processing method according to claim 1, wherein
the license information includes a name of the driver, and
the information processing method further comprises outputting an audio message including the name of the driver through a loudspeaker of the vehicle.

11. The information processing method according to claim 1, wherein
in the storing of the license information, the license information obtained is stored into at least one of the storage provided in the vehicle, the storage installed in a management server of the vehicle, or the storage provided in the information terminal.

12. The information processing method according to claim 2, further comprising:
obtaining setting information pertaining to a setting of the vehicle set by the driver and storing the setting information into a setting storage with the setting information in association with the license information of the driver; and
after the authentication using the digital key, changing the setting of the vehicle based on the setting information stored in the setting storage.

13. The information processing method according to claim 12, wherein
the setting information stored is updated based on setting information newly obtained and set by the driver of the vehicle.

14. The information processing method according to claim 1, further comprising:
obtaining a driving history of the driver of the vehicle and storing the driving history into a history storage with the driving history in association with the license information of the driver; and
calculating, by a navigation system provided in the vehicle, at least one of a recommended route to a destination or an estimated time of arrival at the destination, wherein
in the calculating of the at least one of the recommended route to the destination or the estimated time of arrival at the destination, the recommended route and the estimated time of arrival are calculated based on the driving history stored in the history storage.

15. The information processing method according to claim 1, further comprising:
obtaining a driving history of the driver of the vehicle and storing the driving history into a history storage with the driving history in association with the license information of the driver; and
calculating, by a fuel efficiency computing system provided in the vehicle, at least one of fuel efficiency information or a travelable distance, the fuel efficiency information being information on fuel efficiency in traveling, the travelable distance being a distance travelable with fuel remaining in the vehicle wherein
in the calculating of the at least one of the fuel efficiency information or the travelable distance, the fuel efficiency information and the travelable distance are calculated based on the driving history stored in the history storage.

16. The information processing method according to claim 1, further comprising:
providing a notification to an outside entity in response to an occurrence of a trouble involving the vehicle, the providing of the notification including sending a notification that includes the license information to the outside entity.

17. The information processing method according to claim 1, wherein
the license information is obtained in accordance with a mobile Driver License (mDL) standard.

18. The information processing method according to claim 1, wherein
the license information includes at least one of a license type indicating a type of vehicle that the driver is permitted to drive, a facial photograph of the driver, a name of the driver, a restriction indicating a condition in which the driver is permitted to drive, or an expiration date.

19. A non-transitory computer-readable recording medium having recorded thereon a program that causes a computer to execute the information processing method according to claim 1.

20. An information processing device for a vehicle communicably connected to an information terminal, the information processing device comprising:
an obtainer that obtains license information pertaining to a driver's license of a driver of the vehicle, by communicating with the information terminal; and
a storage controller that stores the license information obtained into a storage.
